(19) United States
(12) Patent Application Publication
(10) Pub. No.: US 2009/0023862 A1
(43) Pub. Date: Jan. 22, 2009

(54) SOLVENTBORNE THERMOSETTING COMPOSITIONS CONTAINING COPOLYMERS OF ISOBUTYLENE TYPE MONOMERS

(75) Inventors: Simion Coca, Pittsburgh, PA (US); Jane N. Valenta, Pittsburgh, PA (US); Steve Valasek, Tarentum, PA (US); John W. Burgman, Brecksville, OH (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/778,820

(22) Filed: Jul. 17, 2007

(51) Int. Cl. C08F 8/00; C08J 3/20

(52) U.S. Cl. 525/194

(57) ABSTRACT

The present invention is directed to a solventborne thermosetting composition comprising:

(a) a polymeric binder comprising a copolymer, said copolymer being a polymerization product of:
(i) 10 to 30 percent by weight, based on the total weight of monomers used to prepare the copolymer, of a monomer having the following structure (I):

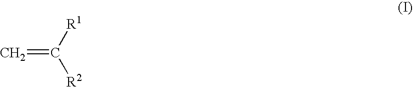

wherein R¹ comprises linear or branched C₁ to C₄ alkyl, and R² comprises methyl, linear, cyclic or branched C₁ to C₂₀ alkyl or alkenyl;
(ii) 5 to 25 percent by weight, based on the total weight of monomers used to prepare the copolymer, of a monomer having aromatic functionality;
(iii) 0 to 60 percent by weight, based on the total weight of monomers used to prepare the copolymer, of an ethylenically unsaturated monomer containing secondary hydroxyl groups; and
(iv) 15 to 50 percent by weight, based on the total weight of monomers used to prepare the copolymer, of an ethylenically unsaturated monomer containing primary hydroxyl groups;

(b) an aminoplast curing agent; and

(c) a compound comprising a capped isocyanate-functional material.

### FIELD OF THE INVENTION

The present invention relates generally to solventborne thermosetting compositions that contain copolymers of vinyl monomers. More specifically, the present invention is directed to solventborne thermosetting compositions that contain functional copolymers containing isobutylene type monomers.

### BACKGROUND OF THE INVENTION

Automotive manufacturers have very strict performance requirements of the coatings that are used in original equipment manufacture. For example, automotive OEM clear top coats are typically required to have a combination of good exterior durability, acid etch and water spot resistance, and excellent gloss and appearance.

Functional polymers used in coating compositions are typically random copolymers that include functional group-containing acrylic and/or methacrylic monomers. Such a functional copolymer will contain a mixture of polymer molecules having varying individual functional equivalent weights and polymer chain structures. In such a copolymer, the functional groups are located randomly along the polymer chain. In addition, the number of functional groups is not divided equally among the polymer molecules, such that some polymer molecules may actually be non-functional.

In a thermosetting composition, the formation of a crosslinked network is dependent on the functional equivalent weight as well as the architecture of the individual polymer molecules that comprise the composition. Polymer molecules having little or no reactive functionality (or having functional groups that are unlikely to participate in crosslinking reactions due to their locations along the polymer chain) will contribute little or nothing to the formation of the crosslinked network, resulting in decreased crosslink density and often compromising physical properties of the finally formed thermoset coating.

Almost no examples of isobutylene-type monomer-containing copolymers in coating compositions can be found in the prior art. This is most likely due to the generally non-reactive nature of isobutylene with acrylic and methacrylic monomers. Reactivity ratios for monomers can be calculated using the Alfrey—Price Q-e values (Robert Z. Greenley, Polymer Handbook, Fourth Edition, Brandrup, Immergut and Gulke, editors, Wiley & Sons, New York, N.Y., pp. 309-319 (1999)). The calculations may be carried out using the formulas I and II:

r₁=(Q₁/Q₂)exp{−e₁(e₁−e₂)} I

r₂=(Q₂/Q₁)exp{−e₂(e₂−e₁)} II

where r₁ and r₂ are the respective reactivity ratios of monomers 1 and 2,and Q₁ and Q₂ and e₁ and e₂ are the respective reactivity and polarity values for the respective monomers (Odian, Principals of Polymerization, 3^{rd} Ed., Wiley-Interscience, New York, N.Y., Chapter 6, pp. 452-467 and 489-491 (1991)). Table 1 shows the calculated reactivity ratios of selected monomers with isobutylene:

TABLE 1

| Monomer | r₁ (isobutylene) | r₂ |
|---|---|---|
| Methyl acrylate | 0.10 | 13.67 |
| Glycidyl methacrylate | 0.08 | 34.17 |
| Methacrylic acid | 0.09 | 39.71 |

As one skilled in the art of polymer chemistry can appreciate, when r₁ is near zero and r₂ has a value of 10 or more, monomer 2 is reactive toward both monomers and monomer 1 is reactive toward neither monomer. In other words, it is extremely difficult to prepare copolymers having significant amounts of both monomers. It is not surprising then that no examples can be found of coating compositions that include isobutylene-type monomer-containing copolymers, because the monomers do not tend to copolymerize.

In some cases, it is observed that various monomers that do not readily homopolymerize are able to undergo rapid copolymerization reactions with each other. The most typical situation occurs when a strong electron donating monomer is mixed with a strong electron accepting monomer from which a regular alternating copolymer results after free radical initiation. Maleic anhydride is a widely used example of a strong electron accepting monomer. Styrene and vinyl ethers are typical examples of electron donating monomers. Systems, such as maleic anhydride-styrene, are known to form charge transfer complexes, which tend to place the monomers in alternating sequence prior to initiation. The application of the free radical initiator “ties” the ordered monomers together to form an alternating copolymer (Cowie, Alternating Copolymers, Plenum, New York (1985)).

When a moderately electron donating monomer, such as isobutylene, is copolymerized with a moderately electron accepting monomer, such as an acrylic ester, poor incorporation of the electron donating monomer results. For example, free radical copolymerization of isobutylene (IB) and acrylic monomers has resulted in copolymers that contain at no more than 20-30% of IB and have low molecular weights because of the degradative chain transfer of IB.

Conjugated monomers, such as acrylic esters and acrylonitrile, have been shown to react with monomers such as propylene, isobutylene, and styrene, in the presence of Lewis acids, such as alkylaluminum halides, to give 1:1 alternating copolymers. The alternating copolymers were obtained when the concentration ratio of the Lewis acids to the acrylic esters was 0.9 and the concentration of IB was greater than the concentration of the acrylic esters (Hirooka et al, J. Polym. Sci. Polym. Chem., 11, 1281 (1973)). The metal halides vary the reactivity of the monomers by complexing with them. The electron donor monomer—electron acceptor monomer—metal halide complex leads to alternating copolymers (Mashita et al. Polymer, Vol. 36, No. 15, pp. 2973-2982, (1995)).

Copolymers of IB and methyl acrylate (MA) have also been obtained by using ethyl aluminum sesquichloride and 2-methyl pentanoyl peroxide as an initiating system. The resulting copolymer has an alternating structure, with either low (Kuntz et al, J. Polym. Sci. Polym. Chem., 16, 1747 (1978)) or high isotacticity in the presence of EtAlCl₂ (10 molar % relative to MA). (Florjanczyk et al, Makromol. Chem., 183, 1081 (1982)).

Another method for making IB copolymers with acrylic esters involved alkyl boron halide, which was found to be much more active than alkyl aluminum halides in forming alternating copolymers. The resulting copolymer was an elastomer of high tensile strength and high thermal decomposition temperature with good oil resistance, especially at elevated temperatures (Mashita et al, Polymer, 36, 2983 (1995)).

Alternating copolymers of isobutylene and methyl acrylate have been prepared using an atom transfer radical polymerization (ATRP) process. The method requires the use of a suitable ATRP initiator, such as 1-phenylethyl bromide, and a suitable transition metal salt, such as CuBr with a ligand, such as 2,2′-bipyridyl, to perform the complex redox initiation and propagation steps of the polymerization process.

Copolymers containing relatively high amounts (≧30 mol %) of IB and acrylic esters have only been attained by free radical polymerization when Lewis acids or ATRP initiation systems have been employed. The polymer that results from such processes requires expensive and time consuming clean up to remove the transition metal salt and/or Lewis acid residues in order to make the polymer commercially useful.

Copolymer compositions that contain Lewis acids and/or transition metals intermingled with the copolymer can have a number of drawbacks when used commercially in coating compositions. First, some Lewis acids and transition metals are toxic and have adverse environmental effects if they are leached from the copolymer and enter the environment. Second, in coating applications the Lewis acids and transition metals may lead to poor color stability when the coating is exposed to UV light or simply cause the coating to discolor through other reactions or interactions. Further, the Lewis acids and transition metals may react with other ingredients in a coating formulation resulting in undesired properties, such as a shortened shelf-life for a given coating formulation.

It would be desirable to develop solventborne thermosetting compositions that comprise functional copolymers having a well-defined polymer chain structure. In particular, alternating copolymers containing isobutylene-type monomers that are substantially free of Lewis acids and transition metals would be desirable. Such compositions would be expected to have a combination of favorable performance properties particularly in coatings applications, such as enhanced acid etch resistance in outdoor exposure tests.

### SUMMARY OF THE INVENTION

The present invention is directed to a curable, solventborne film-forming composition, comprising:

(a) a polymeric binder comprising a copolymer, said copolymer being a polymerization product of:
(i) 10 to 30 percent by weight, based on the total weight of monomers used to prepare the copolymer, of a monomer having the following structure (I):

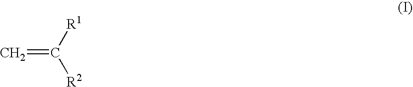

wherein R¹ comprises linear or branched C₁ to C₄ alkyl, and R² comprises methyl, linear, cyclic or branched C₁ to C₂₀ alkyl or alkenyl;
(ii) 5 to 25 percent by weight, based on the total weight of monomers used to prepare the copolymer, of a monomer having aromatic functionality;
(iii) 0 to 60 percent by weight, based on the total weight of monomers used to prepare the copolymer, of an ethylenically unsaturated monomer containing secondary hydroxyl groups; and
(iv) 15 to 50 percent by weight, based on the total weight of monomers used to prepare the copolymer, of an ethylenically unsaturated monomer containing primary hydroxyl groups;

(b) an aminoplast curing agent; and

(c) a compound comprising a capped isocyanate-functional material.

In certain embodiments, at least 15 mol percent of the copolymer comprises residues having the following alternating structural units:

-[DM-AM]-

wherein DM represents a residue from a donor monomer, and AM represents a residue from an acceptor monomer.

### DETAILED DESCRIPTION OF THE INVENTION

It is noted that, as used in this specification and the appended claims, the singular forms “a,” “an,” and “the” include plural referents unless expressly and unequivocally limited to one referent. For example, while reference is made herein, including in the claims, to “a” polymeric binder, “a” monomer having structure I, “a” monomer having aromatic functionality, “an” ethylenically unsaturated monomer, “an” aminoplast curing agent, and the like, mixtures of any of these or other components can be used.

Other than in the operating examples, or where otherwise indicated, all numbers or expressions referring to quantities of ingredients, reaction conditions, etc., used in the specification and claims are to be understood as modified in all instances by the term “about”. Various numerical ranges are disclosed in this patent application. Because these ranges are continuous, they include every value between the minimum and maximum values. Unless expressly indicated otherwise, the various numerical ranges specified in this application are approximations.

The various embodiments and examples of the present invention as presented herein are each understood to be non-limiting with respect to the scope of the invention.

As used herein, the term “copolymer composition” is meant to include a synthesized copolymer as well as residues from initiators, catalysts, and other elements attendant to the synthesis of the copolymer, but not covalently incorporated thereto. Such residues and other elements considered as part of the copolymer composition are typically mixed or co-mingled with the copolymer such that they tend to remain with the copolymer when it is transferred between vessels or between solvent or dispersion media.

As used herein, the term “substantially free” is meant to indicate that a material is present in trace amounts or as an incidental impurity. In other words, the material is not intentionally added to an indicated composition, but, for example, may be present at minor or inconsequential levels because it was carried over as an impurity as part of an intended composition component.

The terms “donor monomer” and “acceptor monomer” are used throughout this application. With regard to the present invention, the term “donor monomer” refers to monomers that have a polymerizable, ethylenically unsaturated group that has relatively high electron density in the ethylenic double bond, and the term “acceptor monomer” refers to monomers that have a polymerizable, ethylenically unsaturated group that has relatively low electron density in the ethylenic double bond. This concept has been quantified to an extent by the Alfrey-Price Q-e scheme (Robert Z. Greenley, Polymer Handbook, Fourth Edition, Brandrup, Immergut and Gulke, editors, Wiley & Sons, New York, N.Y., pp. 309-319 (1999)). All e values recited herein are those appearing in the Polymer Handbook unless otherwise indicated.

In the Q-e scheme, Q reflects the reactivity of a monomer and e represents the polarity of a monomer, which indicates the electron density of a given monomer's polymerizable, ethylenically unsaturated group. A positive value for e indicates that a monomer has a relatively low electron density and is an acceptor monomer, as is the case for maleic anhydride, which has an e value of 3.69. A low or negative value for e indicates that a monomer has a relatively high electron density and is a donor monomer, as is the case for vinyl ethyl ether, which has an e value of −1.80.

As referred to herein, a strong acceptor monomer is meant to include those monomers with an e value greater than 2.0. The term “mild acceptor monomer” is meant to include those monomers with an e value greater than 0.5 up to and including those monomers with an e value of 2.0. Conversely, the term “strong donor monomer” is meant to include those monomers with an e value of less than −1.5, and the term “mild donor monomer” is meant to include those monomers with an e value of less than 0.5 to −1.5.

The present invention is directed to a solventborne film-forming composition that includes a copolymer composition as a polymeric binder. The composition is thermosetting. The copolymer is typically a polymerization product of:
(i) 10 to 30 percent by weight, based on the total weight of monomers used to prepare the copolymer, of a monomer having the following structure (I):

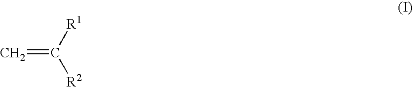

wherein R¹ comprises linear or branched C₁ to C₄ alkyl, and R² comprises methyl, linear, cyclic or branched C₁ to C₂₀ alkyl or alkenyl;
(ii) 5 to 20 percent by weight, based on the total weight of monomers used to prepare the copolymer, of a monomer having aromatic functionality;
(iii) 0 to 60 percent by weight, based on the total weight of monomers used to prepare the copolymer, of an ethylenically unsaturated monomer containing secondary hydroxyl groups; and
(iv) 15 to 50 percent by weight, based on the total weight of monomers used to prepare the copolymer, of an ethylenically unsaturated monomer containing primary hydroxyl groups.

In the monomer (i) having structure I, the group R² may include one or more functional groups selected from hydroxy, epoxy, carboxylic acid, ether, carbamate, and amide. The monomer described by structure I may include, for example, isobutylene, diisobutylene, dipentene, and isoprenol. The monomer of structure I is typically present in the copolymer composition at a level of at least 10 percent by weight, in some cases at least 15 percent by weight, typically at least 20 percent by weight. The monomer of structure I is typically present in the copolymer composition at a level of no more than 30 percent by weight, in some cases no more than 25 percent by weight. The level of the monomer of structure I used is determined by the properties that are to be incorporated into the copolymer composition.

Examples of suitable monomers (ii) having aromatic functionality include alpha-methyl styrene, benzyl acrylate, styrene, and the like. The monomer (ii) is typically present in the copolymer composition at a level of at least 5 percent by weight, in some cases at least 7 percent by weight, typically at least 10 percent by weight. The monomer (ii) is typically present in the copolymer composition at a level of no more than 25 percent by weight, in some cases no more than 15 percent by weight.

Ethylenically unsaturated monomers (iii) containing secondary hydroxyl groups may comprise hydroxypropyl(meth)acrylate and/or similar secondary hydroxyalkyl(meth)acrylate monomers. Beta-hydroxy ester functional monomers can be prepared from ethylenically unsaturated, epoxy functional monomers and carboxylic acids having from 13 to 20 carbon atoms or amines having from 13 to 20 carbon atoms, or from ethylenically unsaturated acid- or amine-functional monomers and epoxy compounds containing at least 5 carbon atoms and which are not addition polymerizable.

Useful ethylenically unsaturated, epoxy functional monomers used to prepare the beta-hydroxy ester functional monomers include, but are not limited to, glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. Glycidyl acrylate and glycidyl methacrylate are used most often. Examples of carboxylic acids include, but are not limited to, saturated monocarboxylic acids such as isostearic acid and aromatic unsaturated carboxylic acids. Examples of amines include 1° and 2° amines commonly known in the art such as methylethylamine, dimethyl amine, and the like.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid- or amine-functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, often containing from 8 to 30 carbon atoms, such as butyl glycidyl ether, octyl glycidyl ether, phenyl glycidyl ether and para-(tertiary butyl)phenyl glycidyl ether. Commonly used glycidyl esters include those of the structure:

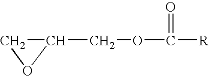

where R is a hydrocarbon radical containing from 4 to 26 carbon atoms. Often, R is a branched hydrocarbon group having from 8 to 10 carbon atoms, such as neopentanoate, neoheptanoate or neodecanoate. Suitable glycidyl esters of carboxylic acids include VERSATIC ACID 911 and CARDURA E, each of which is commercially available from Shell Chemical Co.

The secondary hydroxyl functional monomer (iii) is typically present in the copolymer composition at a level of 0 to 60 percent by weight; often at least 5 percent by weight, in some cases at least 7 percent by weight, typically at least 10 percent by weight. The monomer (iii) is typically present in the copolymer composition at a level of no more than 60 percent by weight, in some cases no more than 55 percent by weight, often no more than 40 percent by weight.

Ethylenically unsaturated monomer(s) (iv) containing primary hydroxyl groups may be any of those known in the art, and typically comprise hydroxyethyl(meth)acrylate and/or 4-hydroxybutyl(meth)acrylate.

The primary hydroxyl functional monomer (iv) is typically present in the copolymer composition at a level of 15 to 50 percent by weight; often at least 25 percent by weight, typically at least 30 percent by weight. The monomer (iv) is typically present in the copolymer composition at a level of no more than 50 percent by weight, in some cases no more than 45 percent by weight, often no more than 40 percent by weight.

The polymeric binder (a) is typically present in the film-forming composition of the present invention in an amount of at least 10 percent by weight, often at least 25 percent by weight, more often at least 40 percent by weight, based on the total weight of (a), (b), and (c) in the film-forming composition. The polymeric binder (a) is typically present in the film-forming composition of the present invention in an amount of no more than 90 percent by weight, often no more than 80 percent by weight, more often no more than 75 percent by weight, based on the total resin weight of (a), (b), and (c), in the film-forming composition.

The solventborne film-forming composition of the present invention further comprises (b) an aminoplast curing agent. Useful aminoplast resins include, but are not limited to, those based on the addition products of formaldehyde with an amino- or amido-group carrying substance. Condensation products obtained from the reaction of alcohols and formaldehyde with melamine, urea or benzoguanamine are most commonly used herein. While the aldehyde employed is most often formaldehyde, other similar condensation products can be made from other aldehydes, such as acetaldehyde, crotonaldehyde, acrolein, benzaldehyde, furfural, glyoxal and the like. The aminoplast resins often contain methylol or similar alkylol groups, and in most instances at least a portion of these alkylol groups are etherified by reaction with an alcohol. Any monohydric alcohol can be employed for this purpose, including but not limited to methanol, ethanol, propanol, butanol, pentanol, hexanol, heptanol, as well as benzyl alcohol and other aromatic alcohols, cyclic alcohols such as cyclohexanol, monoethers of glycols, and halogen-substituted or other substituted alcohols such as 3-chloropropanol and butoxyethanol. The aminoplast resin most often used in the film-forming composition of the present invention is CYMEL 202, commercially available from CYTEC Industries, Inc.

The aminoplast curing agent (b) is typically present in the film-forming composition of the present invention in an amount of at least 10 percent by weight, often at least 15 percent by weight, more often at least 20 percent by weight, based on the total weight of (a), (b), and (c) in the film-forming composition. The aminoplast curing agent (b) is typically present in the film-forming composition of the present invention in an amount of no more than 90 percent by weight, often no more than 50 percent by weight, more often no more than 35 percent by weight, based on the total resin weight of (a), (b), and (c), in the film-forming composition. Specific amounts are dependent on the degree of alkylation of the aminoplast

The solventborne film-forming composition of the present invention further comprises (c) a compound comprising a capped isocyanate-functional material. Typically this material is present in an amount of 3 to 5 percent by weight, based on the total weight of (a), (b), and (c). The compound (c) may be any capped isocyanate functional material known in the art of surface coatings. Most often, the compound (c) comprises a carbamoyl triazine of the formula C₃N₃(NHCOXR)₃ where X is —NH—, —O—, or —CH₂—, and R is a lower alkyl group having from one to twelve carbon atoms or mixtures of lower alkyl groups, such as methyl, ethyl, propyl, butyl, n-octyl and 2-ethylhexyl. Such compounds and their preparation are described in detail in U.S. Pat. No. 5,084,541, which is hereby incorporated by reference.

In certain embodiments of the present invention, at least 15 mol percent of the copolymer used in the film-forming composition comprises residues having the following alternating structural units:

-[DM-AM]-

wherein DM represents a residue from a donor monomer, and AM represents a residue from an acceptor monomer.

The donor monomer typically comprises the monomer (i) as described above having the structure (I). The donor monomer may further comprise other mild and/or strong donor monomers as defined herein and as known in the art, such as those listed in standard polymer handbooks. For example, other donor monomers that may be used in the preparation of the copolymer include, but are not limited to, ethylene, butene, styrene, substituted styrenes, methyl styrene, substituted styrenes, vinyl ethers, vinyl esters, vinyl pyridines, divinyl benzene, vinyl naphthalene, and divinyl naphthalene. Vinyl esters include vinyl esters of carboxylic acids, which include, but are not limited to, vinyl acetate, vinyl butyrate, vinyl 3,4-dimethoxybenzoate, and vinyl benzoate. The use of other donor monomers is optional. The level of other donor monomers used is determined by the properties that are to be incorporated into the copolymer composition. Residues from the other donor monomers may be present in the copolymer composition in any range of values inclusive of those stated above. Alpha-methyl styrene, a monomer (ii) having aromatic functionality, is often used as an additional donor monomer in amounts as discussed above.

The acceptor monomers used as part of the alternating donor monomer-acceptor monomer units along the copolymer chain are not to be construed as Lewis acids, the use of which as catalysts is undesirable in certain embodiments of the present invention as discussed below. Otherwise, any suitable acceptor monomer may be used. Suitable acceptor monomers include strong acceptor monomers and mild acceptor monomers. For example, suitable acceptor monomers include the ethylenically unsaturated monomers (iii) containing secondary hydroxyl groups described above; ethylenically unsaturated monomers (iv) containing primary hydroxyl groups described above; benzyl acrylate, a monomer (ii) having a aromatic functionality; and any other mild or strong acceptor monomers as defined herein.

A non-limiting class of suitable acceptor monomers are those described by the structure (II):

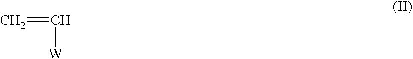

where W is selected from the group consisting of —CN, —X, and —C(═O)—Y, wherein Y is selected from the group consisting of —NR³₂, —O—R⁵—O—C(═O)—NR³₂, and —OR⁴, R³ is selected from the group consisting of H, linear or branched C₁ to C₂₀ alkyl, and linear or branched C₁ to C₂₀ alkylol, R⁴ is selected from the group consisting of H, poly(ethylene oxide), poly(propylene oxide), linear or branched C₁ to C₂₀ alkyl, alkylol, aryl and aralkyl, linear or branched C₁ to C₂₀ fluoroalkyl, fluoroaryl and fluoroaralkyl, and a polysiloxane radical, R⁵ is a divalent linear or branched C₁ to C₂₀ alkyl linking group, and X is a halide.

A class of mild acceptor monomers that may be included in the present copolymer composition are acrylic acceptor monomers. Suitable acrylic acceptor monomers include those described by structure (III):

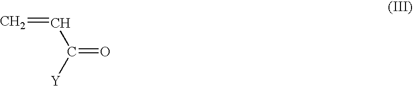

where Y is selected from the group consisting of —NR³₂, —O—R⁵—O—C(═O)—NR³₂, and —OR⁴, R³ is selected from the group consisting of H, linear or branched C₁ to C₂₀ alkyl, and linear or branched C₁ to C₂₀ alkylol, R⁴ is selected from the group consisting of H, poly(ethylene oxide), poly(propylene oxide), linear or branched C₁ to C₂₀ alkyl, alkylol, aryl and aralkyl, linear or branched C₁ to C₂₀ fluoroalkyl, fluoroaryl and fluoroaralkyl, and a polysiloxane radical, and R⁵ is a divalent linear or branched C₁ to C₂₀ alkyl linking group.

Particularly useful acrylic acceptor monomers are those described by structure III where Y includes at least one functional group selected from hydroxy, amide, oxazoline, aceto acetate, blocked isocyanate, carbamate, and amine. Y groups may be converted to salt groups selected from carboxylic acid salt, amine salt, quaternized ammonium, quaternized phosphonium and ternary sulfonium using techniques known to those skilled in the art.

Examples of other suitable acceptor monomers include, but are not limited to, hydroxyethyl acrylate, hydroxypropyl acrylate, 4-hydroxybutyl acrylate, acrylic acid, methyl acrylate, ethyl acrylate, butyl acrylate, isobutyl acrylate, isobornyl acrylate, dimethylaminoethyl acrylate, acrylamide, perfluoro methyl ethyl acrylate, perfluoro ethyl ethyl acrylate, perfluoro butyl ethyl acrylate, trifluoromethyl benzyl acrylate, perfluoro alkyl ethyl, acryloxyalkyl terminated polydimethylsiloxane, acryloxyalkyl tris(trimethylsiloxy silane), and acryloxyalkyl trimethylsiloxy terminated polyethylene oxide, chlorotrifluoro ethylene, glycidyl acrylate, 2-ethylhexyl acrylate, and n-butoxy methyl acrylamide.

Suitable other mild acceptor monomers that may be used in the copolymer include, but are not limited to, acrylonitrile, methacrylonitrile, vinyl halides, crotonic acid, vinyl alkyl sulfonates, and acrolein. Vinyl halides include, but are not limited to, vinyl chloride and vinylidene fluoride. The level of other acceptor monomers used is determined by the properties that are to be incorporated into the copolymer composition.

A non-limiting list of published e values for monomers that may be included as donor monomers described by structure I, additional donor monomers, and acrylic acceptor monomers to prepare the copolymer used in the film-forming composition of the present invention are shown in Table 2.

TABLE 2
Alfrey-Price e values for Selected Monomers

| Monomer | e value |
|---|---|
| Monomers of structure 1 | |
| Isobutylene | −1.20¹ |
| Diisobutylene | 0.49² |
| Other Donor Monomers | |
| Vinyl acetate | −0.22¹ |
| Vinyl Pivalate | −0.75³ |
| Vinyl Neodecanoate | −0.64³ |
| Vinyl Neononanoate | −0.48³ |
| a-Methyl Styrene | −0.81¹ |
| Methyl Methacrylate | 0.40¹ |
| Acrylic Acceptor Monomers | |
| Acrylic Acid | 0.88¹ |
| Acrylamide | 0.54¹ |
| Acrylonitrile | 1.23¹ |
| Methyl Acrylate | 0.64¹ |
| Ethyl Acrylate | 0.55¹ |
| Butyl Acrylate | 0.85¹ |
| Benzyl acrylate | 1.13¹ |
| Glycidyl acrylate | 1.28¹ |

¹Polymer Handbook, Fourth Edition (1999)
²Rzaev et al., Eur. Polym. J., Vol. 24, No. 7, pp. 981-985 (1998)
³Polymer Handbook, Second Edition (1975)

In certain embodiments, the copolymer used in the polymeric binder (a) in the film-forming compositions of the present invention is substantially free of maleic anhydride monomer segments, maleate ester monomer segments, fumaric acid monomer segments, and fumarate ester monomer segments, which usually have e values greater than 2.0. These types of multifunctional monomers can provide too many functional groups to the copolymer. This can be undesirable, for example, in coatings where a thermosetting composition may have a short shelf-life due to the overly functional nature of the copolymer.

Further, in certain embodiments, the copolymer composition used in the film-forming composition of the present invention is substantially free of transition metals and Lewis acids which, as noted above, have been used in the art to make alternating copolymers of mild donor monomers and mild acceptor monomers. The present invention does not need to use transition metal or Lewis acid adjuncts in preparing the copolymer composition, therefore, they do not need to be removed after polymerization and the resulting copolymer compositions will not suffer the drawbacks that may be observed with those copolymers that contain transition metals or Lewis acids.

The copolymer has a molecular weight of at least 250, in many cases at least 500, typically at least 1,000, and, in some cases, at least 2,000. The present copolymer may have a molecular weight of up to 1,000,000, in many cases up to 500,000, typically up to 100,000, and, in some cases, up to 50,000. Certain applications will require that the molecular weight of the present copolymer not exceed 30,000, in some cases not exceed 25,000, in other cases not exceed 20,000, and, in certain instances, not exceed 16,000. The molecular weight of the copolymer is selected based on the properties that are to be incorporated into the copolymer composition. The molecular weight of the copolymer may vary in any range of values inclusive of those stated above.

The polydispersity index (PDI) of the copolymer is usually less than 4, in many cases less than 3.5, typically less than 3.0, and, in some cases, less than 2.5. As used herein and in the claims, “polydispersity index” is determined from the following equation: (weight average molecular weight (Mw)/number average molecular weight (Mn)). A monodisperse polymer has a PDI of 1.0. Further, as used herein, Mn and Mw are determined from gel permeation chromatography using polystyrene standards.

The copolymer composition used in the polymeric binder (a) in the film-forming composition of the present invention can be prepared by any method known in the art, such as a method including the steps of (a) providing a monomer composition comprising one or more monomers of structure I; (b) mixing an ethylenically unsaturated monomer composition comprising monomers (ii) (iii) and (iv) with (a) to form a total monomer composition substantially free of maleic anhydride, fumaric acid, maleate- and fumarate-type monomers; and (c) polymerizing the total monomer composition in the presence of a free radical initiator in the substantial absence of transition metals and Lewis acids.

In the preparation of the copolymer, an excess of monomer of structure I may be used and the unreacted monomer of structure I removed from the resulting copolymer composition by evaporation. The removal of unreacted monomer is typically facilitated by the application of a vacuum to the reaction vessel.

Any suitable free radical initiator may be used in the making of the copolymer. Examples of suitable free radical initiators include, but are not limited to, thermal free radical initiators, photo-initiators, and redox initiators. Examples of suitable thermal free radical initiators include, but are not limited to, peroxide compounds, azo compounds, and persulfate compounds.

Examples of suitable peroxide compound initiators include, but are not limited to, hydrogen peroxide, methyl ethyl ketone peroxides, benzoyl peroxides, di-t-butyl peroxide, di-t-amyl peroxide, dicumyl peroxide, diacyl peroxides, decanoyl peroxides, lauroyl peroxides, peroxydicarbonates, peroxyesters, dialkyl peroxides, hydroperoxides, peroxyketals, and mixtures thereof.

Examples of suitable azo compounds include, but are not limited to, 4-4′-azobis(4-cyanovaleric acid), 1-1′-azobiscyclohexanecarbonitrile), 2-2′-azobisisobutyronitrile, 2-2′-azobis(2-methylpropionamidine)dihydrochloride, 2-2′-azobis(2-methylbutyronitrile), 2-2′-azobis(propionitrile), 2-2′-azobis(2,4-dimethylvaleronitrile), 2-2′-azobis(valeronitrile), 2,2′-azobis[2-methyl-N-(2-hydroxyethyl)propionamide], 4,4′-azobis(4-cyanopentanoic acid), 2,2′-azobis(N,N′-dimethyleneisobutyramidine), 2,2′-azobis(2-amidinopropane)dihydrochloride, 2,2′-azobis(N,N′-dimethyleneisobutyramidine)dihydrochloride, and 2-(carbamoylazo)-isobutyronitrile.

In an embodiment of the present invention, the ethylenically unsaturated monomer composition and the free radical polymerization initiator are separately and simultaneously added to and mixed with the monomer composition comprising one or more monomers of structure I. The ethylenically unsaturated monomer composition and the free radical polymerization initiator may be added to the monomer composition comprising one or more monomers of structure I over a period of at least 15 minutes, in some cases at least 20 minutes, typically at least 30 minutes, and, in some cases, at least 1 hour. The ethylenically unsaturated monomer composition and the free radical polymerization initiator may further be added to the donor monomer composition over a period of not more than 24 hours, in some case not more than 18 hours, typically not more than 12 hours, and, in some cases, not more than 8 hours. When preparing alternating copolymers, the time for adding the ethylenically unsaturated monomer must be sufficient to maintain a suitable excess of monomer of structure I over unreacted acceptor monomer to encourage the formation of donor monomer—acceptor monomer alternating segments. The addition time is not so long as to render the process economically unfeasible on a commercial scale. The addition time may vary in any range of values inclusive of those stated above.

After mixing, or during addition and mixing, polymerization of the monomers takes place. The polymerization can be run at any suitable temperature. Suitable temperature for the present method may be ambient, at least 50° C., in many cases at least 60° C., typically at least 75° C., and, in some cases, at least 100° C. Suitable temperature for the present method may further be described as being not more than 300° C., in many cases not more than 275° C., typically not more than 250° C., and, in some cases, not more than 225° C. The temperature is typically high enough to encourage good reactivity from the monomers and initiators employed. However, the volatility of the monomers and corresponding partial pressures create a practical upper limit on temperature determined by the pressure rating of the reaction vessel. The polymerization temperature may vary in any range of values inclusive of those stated above.

The polymerization can be run at any suitable pressure. A suitable pressure for the present method may be ambient, at least 1 psi, in many cases at least 5 psi, typically at least 15 psi, and, in some cases, at least 20 psi. Suitable pressures for the present method may further be described as being not more than 200 psi, in many cases not more than 175 psi, typically not more than 150 psi, and, in some cases, not more than 125 psi. The pressure is typically high enough to maintain the monomers and initiators in a liquid phase. The pressures employed have a practical upper limit based on the pressure rating of the reaction vessel employed. The pressure during polymerization temperature may vary in any range of values inclusive of those stated above.

Optional ingredients such as, for example, plasticizers, surfactants, thixotropic agents, anti-gassing agents, anti-oxidants, colorants, UV light absorbers and similar additives conventional in the art may be included in the film-forming composition of the present invention. These ingredients are typically present at up to 40% by weight based on the total weight of resin solids.

The coatings of the present invention can also include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference, and U.S. Provisional Application No. 60/482,167 filed Jun. 24, 2003, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, when used, the colorant is incorporated into the coating composition in amounts up to 80 percent by weight based on the total weight of coating solids. Metallic pigment may be employed in amounts of 0.5 to 25 percent by weight based on the total weight of coating solids.

The curable compositions described above can be applied to various substrates including but not limited to wood; metals including but not limited to ferrous substrates and aluminum substrates; glass; plastic, plastic and sheet molding compound-based plastics.

The compositions can be applied by conventional means including but not limited to brushing, dipping, flow coating, spraying, and the like, but they are most often applied by spraying. The usual spray techniques and equipment for air spraying, airless spray, and electrostatic spraying employing manual and/or automatic methods can be used.

Upon application to a substrate, the composition is allowed to coalesce to form a substantially continuous film on the substrate. Typically, the dry film thickness will be 0.01 to 5 mils (0.254 to 127 microns), such as 0.1 to 2 mils (2.54 to 50.8 microns) in thickness. The film is formed on the surface of the substrate by driving water and any coalescing solvents out of the film by heating or by an air drying period. The heating may be for only a short period of time, sufficient to ensure that any subsequently applied coatings can be applied to the film without dissolving the composition and/or causing other issues. Suitable drying conditions will depend on the particular composition but, in general, a drying time of from 1 to 5 minutes at a temperature of 68-250° F. (20-121° C.) will be adequate. More than one coat of the composition may be applied to develop the optimum appearance. Between coats, the previously applied coat may be flashed, that is, exposed to ambient conditions for 1 to 20 minutes.

The coalesced curable composition is next cured, typically by the application of heat. As used herein, including in the claims, by “cured” is meant a crosslink network is formed by covalent bond formation, e.g., between the functional groups of the aminoplast curing agent and the hydroxy groups of the polymer. The temperature at which the composition of the present invention cures is variable and depends in part on the type and amount of catalyst used. Typically, the composition has a cure temperature within the range of 130° C. to 160° C., such as from 140° C. to 150° C.

In accordance with the present invention, there is further provided a multi-component composite coating composition that includes a base coat deposited from a pigmented film-forming composition; and a transparent top coat applied over the base coat. Either the base coat or the transparent top coat or both coats may include the curable film-forming composition described above. The multi-component composite coating composition as described herein is commonly referred to as a color-plus-clear coating composition.

The pigmented film-forming composition from which the base coat is deposited can be the film-forming composition of the present invention or any other compositions useful in coatings applications, particularly automotive applications in which color-plus-clear coating compositions are extensively used. Pigmented film-forming compositions conventionally comprise a resinous binder and a colorant, such as one or more of those described above. Particularly useful resinous binders are acrylic polymers, polyesters including alkyds, polyurethanes, and the copolymer composition of the present invention.

For example, the resinous binders for the pigmented film-forming base coat composition can be organic solvent-based materials, such as those described in U.S. Pat. No. 4,220,679, note column 2, line 24 through column 4, line 40, incorporated herein by reference. Also, water-based coating compositions such as those described in U.S. Pat. Nos. 4,403,003, 4,147,679, and 5,071,904, incorporated herein by reference, can be used as the binder in the present pigmented film-forming composition.

Ingredients that may be optionally present in the pigmented film-forming base coat composition are those which are well known in the art of formulating surface coatings and include but are not limited to surfactants, flow control agents, thixotropic agents, fillers, anti-gassing agents, organic co-solvents, catalysts, and other customary auxiliaries. Examples of these optional materials and suitable amounts are described in U.S. Pat. Nos. 4,220,679, 4,403,003, 4,147,769, and 5,071,904.

The pigmented film-forming base coat compositions of the present invention can be applied to any of the substrates described above by any conventional coating techniques such as those described above, but are most often applied by spraying. The usual spray techniques and equipment for air spraying, airless spray, and electrostatic spraying employing either manual or automatic methods can be used. The pigmented film-forming composition can be applied in an amount sufficient to provide a base coat having a dry film thickness of 0.1 to 5 mils (2.5 to 125 microns), such as 0.1 to 2 mils (2.5 to 50 microns).

After deposition of the pigmented film-forming base coat composition onto the substrate, and prior to application of the transparent top coat, the base coat can be cured or alternatively dried. In drying the deposited base coat, at least some of the organic solvent and/or water is driven out of the base coat film by heating or the passage of air over its surface. Suitable drying conditions will depend on the particular base coat composition used and/or on the ambient humidity in the case of certain water-based compositions. In general, drying of the deposited base coat is performed over a period of from 1 to 15 minutes and at a temperature of 21° C. to 93° C.

The transparent top coat can be applied over the deposited base coat by any of the methods by which coatings are known to be applied. In an embodiment of the present invention, the transparent top coat is applied by electrostatic spray application. When the transparent top coat is applied over a deposited base coat that has been dried but not cured, the two coatings can be co-cured to form the multi-component composite coating composition of the present invention. Both the base coat and top coat can be heated together to conjointly cure the two layers. Typically, curing conditions of 130° C. to 160° C. for a period of 20 to 30 minutes are employed. The transparent top coat typically has a dry film thickness within the range of 0.5 to 6 mils (13 to 150 microns), e.g., from 1 to 3 mils (25 to 75 microns). Alternative curing methods and conditions/parameters can be used if desired.

The present invention is more particularly described in the following examples, which are intended to be illustrative only, since numerous modifications and variations therein will be apparent to those skilled in the art. Unless otherwise specified, all parts and percentages are by weight. Examples A and B demonstrate preparation of film-forming resins suitable for use in compositions of the present invention. Example C illustrates the preparation of a comparative resin that does not contain any monomer having the structure (I) defined above.

### EXAMPLE A

### Synthesis of copolymer Isobutylene/a-Methyl Styrene-alt-Hydroxyethyl acrylate/Acrylic Acid/CARDURA E

| | Ingredients | Parts by weight (grams) |
|---|---|---|
| Charge 1 | CARDURA E | 734.00 |
| Charge 2 | Isobutylene | 284.00 |
| Charge 3 | Di-t-amyl Peroxide | 80.00 |
| Charge 4 | Hydroxyethyl Acrylate | 360.00 |
| | a-Methyl Styrene | 412.00 |
| | Acrylic acid | 210.00 |
| Charge 5 | DOWANOL PM Acetate | 996.00 |

Charge 1 was added to a 4-liter stirred stainless steel pressure reactor. The reactor was then pressurized with nitrogen to 5 psig pad on reactor. The agitation on the reactor was set at 500 rpm and the reactor temperature was adjusted to 175° C. Charge 2, 3 and 4 were added to the reactor over 2.0 hours. During the monomer addition the temperature was maintained 175° C. at 190 PSI. After Charge 2, 3, and 4 were in the reactor, the reaction mixture was held for 2 hours. The reactor was then cooled to 100° C., and vented. Charge 5 was added to the reactor. The final solids content of the resulting polymer was determined to be 62.5% determined at 110° C. for one hour. The copolymer had number average molecular weight, Mₙ=2080 and polydispersity M_{w}/Mₙ=2.4 (determined by gel permeation chromatography using polystyrene as a standard). The hydroxyl number was 115 and the acid value was 0.25.

### EXAMPLE B

### Synthesis of copolymer Isobutylene/Styrene-alt-Hydroxyethyl acrylate/Acrylic Acid/CARDURA E

| | Ingredients | Parts by weight (grams) |
|---|---|---|
| Charge 1 | CARDURA E | 734.00 |
| Charge 2 | Isobutylene | 284.00 |
| Charge 3 | Di-t-amyl Peroxide | 80.00 |
| Charge 4 | Hydroxyethyl Acrylate | 360.00 |
| | Styrene | 412.00 |
| | Acrylic acid | 210.00 |
| Charge 5 | DOWANOL PM Acetate | 996.00 |

Charge 1 was added to a 4-liter stirred stainless steel pressure reactor. The reactor was then pressured with nitrogen to 5 psig pad on reactor. The agitation on the reactor was set at 500 rpm and the reactor temperature was adjusted to 175° C. Charge 2, 3 and 4 were added to the reactor over 2.0 hours. During the monomer addition the temperature was maintained 175° C. at 100 PSI. After Charge 2, 3, and 4 were in the reactor, the reaction mixture was held for 2 hours. The reactor was than cooled to 100° C., and vented. Charge 5 was added to the reactor. The final solids content of the resulting polymer was determined to be 62.34% determined at 110° C. for one hour. The copolymer had number average molecular weight, Mₙ=2230 and polydispersity M_{w}/Mₙ=2.4 (determined by gel permeation chromatography using polystyrene as a standard). The hydroxyl number was 118 and the acid value was 0.07.

### EXAMPLE C

### Comparative

### Synthesis of copolymer a-Methyl Styrene/Butyl Acrylate/Hydroxyethyl acrylate/Acrylic Acid/CARDURA E

| | Ingredients | Parts by weight (grams) |
|---|---|---|
| Charge 1 | CARDURA E | 2752.50 |
| | DOWANOL PM Acetate | 375.00 |
| Charge 2 | Butyl Acrylate | 1029.00 |
| | Di-t-amyl Peroxide | 375.00 |
| | Hydroxyethyl Acrylate | 1350.00 |
| | a-Methyl Styrene | 1543.00 |
| | Acrylic acid | 825.00 |
| Charge 3 | DOWANOL PM Acetate | 3363.50 |

Charge 1 was added to a 12-liter flask stirred reactor. The reactor was then pressured with nitrogen to 5 psig pad on reactor. The agitation on the reactor was set at 500 rpm and the reactor temperature was adjusted to 175° C. Charge 2 was added to the reactor over 4.0 hours. During the monomer addition the temperature was maintained at 175° C. After Charge 2 was in the reactor, the reaction mixture was held for 2 hours. The reactor was than cooled to 100° C., and Charge 3 was added to the reactor. The final solids content of the resulting polymer was determined to be 67.35% determined at 110° C. for one hour. The copolymer had number average molecular weight, Mₙ=2040 and polydispersity M_{w}/Mₙ=2.3 (determined by gel permeation chromatography using polystyrene as a standard). The hydroxyl number was 108.6 and the acid value was 3.22.

The resins of examples A to C were used to prepare coating compositions as described below.

Pre-mixture A was prepared by mixing the following components sequentially with mild agitation. In each case, the resin was added to 86 parts by weight (39 Solids) of the pre-mixture.

Pre-Mixture A

| | Parts by | Solid weights |
|---|---|---|
| Ingredient | weight (grams) | (grams) |
| Xylene | 10 | — |
| Butanol | 10 | |
| Butyl CARBITOL¹ | 4 | |
| Butyl CELLOSOLVE Acetate² | 2 | |
| AROMATIC 150 | 10 | |
| TINUVIN 928³ | 1.50 | 1.50 |
| TINUVIN 292⁴ | 0.80 | 0.80 |
| TINUVIN 400⁵ | 1.2 | 1.0 |
| CYMEL 202⁶ | 40 | 32 |
| Acid catalyst⁷ | 0.7 | 0.50 |
| LAROTACT LR 9018⁸ | 6.0 | 3.0 |
| WORLEE 315⁹ | 0.10 | 0.02 |

¹Diethylene glycol monobutyl ether available from Dow Chemical Co.
²Solvent available from Union Carbide Corp.
³UV absorber available from Ciba Specialty Chemicals Corp.
⁴Sterically hindered amine light stabilizer available from Ciba Specialty Chemicals Corp.
⁵UV absorber available from Ciba Specialty Chemicals Corp.
⁶Melamine formaldehyde resin available from Cytec Industries, Inc.
⁷Phenyl acid phosphate acid solution available from Islechem, LCC.
⁸Tris (alkyl carbamoyl) triazine available from BASF AG.
⁹Silicone paint additive solution available from Worlee Chemie, GMHB.

TABLE 1

| | | | Example 3 |
|---|---|---|---|
| Ingredient | Example 1 | Example 2 | Comparative |
| Example A | 104 | | |
| | (65) | | |
| Example B | | 105 | |
| | | (65) | |
| Example C | | | 100 |
| | | | (65) |

Samples were reduced to 33″. Viscosity was measured in seconds with a #4 FORD efflux cup at ambient temperature. The film forming compositions of Examples 1 through 3 were spray applied to a pigmented basecoat to form color-plus-clear composite coatings over primed electrocoated steel panels. The panels used were cold rolled steel panels (size 4 inches×12 inches (10.16 cm by 30.48 cm)). Panels for Examples 1 through 3 were coated with ED6060 electrocoat and 1177225A primer, both available from PPG Industries, Inc.

Examples 1 through 3 used Obsidian Schwartz, a black waterborne basecoat, available from PPG Industries, Inc.

Basecoats were automated spray applied to the electrocoated and primed steel panels at ambient temperature (70° F. (21° C.)). A dry film thickness of 0.6 to 0.8 mils (15 to 20 micrometers) was targeted for the basecoats. The water-borne basecoat panels were dehydrated for 10 minutes@176° F. (80° C.) prior to clearcoat application.

The clear coating compositions were each automated spray applied to a basecoated panel at ambient temperature in two coats with an ambient flash between applications. Clearcoats were targeted for a 1.6 to 1.8 mils (41 to 46 micrometers) dry film thickness. All coatings were allowed to air flash at ambient temperature before the oven. Panels were baked for thirty minutes at 285° F. (141° C.) to fully cure the coating(s). The panels were baked in the horizontal position. Jacksonville etch ratings for the coatings are reported below in Table 2.

TABLE 2

| Example Number | Jacksonville Etch Rating* |
|---|---|
| 1 | 5 |
| 2 | 8 |
| 3 | 9 |
| Comparative | |

*Test panels are exposed in Jacksonville, Florida, from the last week of May through the last week of August of a calendar year. This is the standard location and exposure period (summer months) established by the North American automobile manufacturers. Upon exposure completion, the panels are hand washed with soap and water, and then rinsed with water. The rinse water is removed by squeegee, and then the panels are allowed to dry at room temperature. The panels are rated on a scale of 0 to 10 against a set of reference standards comparable to those used by General Motors Company. A rating of ‘0’ is outstanding, with no visible etching or water spotting. The severity of etch steadily increases up through the rating of ‘10’, which is severe etching and water spotting compared to standard panels based on visual observations.

Data in the tables indicate that curable film-forming compositions prepared according to the present invention demonstrate improved environmental etch resistance compared to film-forming compositions that do not contain film-forming resins prepared from monomers having structure (I).

The present invention has been described with reference to specific details of particular embodiments thereof. It is not intended that such details be regarded as limitations upon the scope of the invention except insofar as and to the extent that they are included in the accompanying claims.

We claim:

1. A curable, solventborne film-forming composition comprising:
(a) a polymeric binder comprising a copolymer, said copolymer being a polymerization product of:
(i) 10 to 30 percent by weight, based on the total weight of monomers used to prepare the copolymer, of a monomer having the following structure (I): 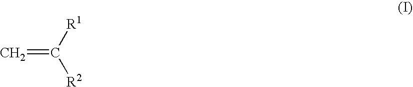
wherein R¹ comprises linear or branched C₁ to C₄ alkyl, and R² comprises methyl, linear, cyclic or branched C₁ to C₂₀ alkyl or alkenyl;
(ii) 5 to 25 percent by weight, based on the total weight of monomers used to prepare the copolymer, of a monomer having aromatic functionality;
(iii) 0 to 60 percent by weight, based on the total weight of monomers used to prepare the copolymer, of an ethylenically unsaturated monomer containing secondary hydroxyl groups; and
(iv) 15 to 50 percent by weight, based on the total weight of monomers used to prepare the copolymer, of an ethylenically unsaturated monomer containing primary hydroxyl groups;
(b) an aminoplast curing agent; and
(c) a compound comprising a capped isocyanate-functional material.

2. The film-forming composition of claim 1, wherein the monomer (i) comprises isobutylene, diisobutylene, dipentene, and/or isoprenol.

3. The film-forming composition of claim 1, wherein the group R² of the monomer of structure I includes a functional group comprising hydroxy, epoxy, carboxylic acid, ether, carbamate, and/or amide.

4. The film-forming composition of claim 1, wherein the amount of the monomer (i) used to prepare the copolymer is 10 to 25 percent by weight, based on the total weight of monomers used to prepare the copolymer.

5. The film-forming composition of claim 1, wherein the monomer (ii) comprises styrene, alpha-methyl styrene, and/or benzyl(meth)acrylate.

6. The film-forming composition of claim 1, wherein the amount of the monomer (ii) used to prepare the copolymer is 10 to 25 percent by weight, based on the total weight of monomers used to prepare the copolymer.

7. The film-forming composition of claim 1, wherein the amount of the monomer (iii) used to prepare the copolymer is 5 to 55 percent by weight, based on the total weight of monomers used to prepare the copolymer.

8. The film-forming composition of claim 7, wherein the monomer (iii) comprises an ethylenically unsaturated acid functional monomer and an epoxy compound containing at least 5 carbon atoms which is not polymerizable with the ethylenically unsaturated acid functional monomer.

9. The film-forming composition of claim 7, wherein the monomer (iii) comprises hydroxypropyl(meth)acrylate, a reaction product of an ethylenically unsaturated, epoxy functional monomer and a carboxylic acid having from 13 to 20 carbon atoms or an amine having from 13 to 20 carbon atoms, and/or a reaction product of an ethylenically unsaturated acid- or amine-functional monomer and an epoxy compound containing at least 5 carbon atoms and which is not addition polymerizable.

10. The film-forming composition of claim 1, wherein the monomer (iv) comprises hydroxyethyl(meth)acrylate and/or 4-hydroxybutyl(meth)acrylate.

11. The film-forming composition of claim 1, wherein the capped isocyanate-functional material comprises a carbamoyl triazine of the formula C₃N₃(NHCOXR)₃ where X is —NH—, oxygen, or —CH₂—, and R is a lower alkyl group having from one to twelve carbon atoms or a mixture of lower alkyl groups.

12. The film-forming composition of claim 1, wherein the polymeric binder (a) is present in the film-forming composition in an amount of 10 to 90 percent by weight, based on the total weight of (a), (b), and (c).

13. The film-forming composition of claim 1, wherein the aminoplast curing agent (b) is present in the film-forming composition in an amount of 10 to 90 percent by weight, based on the total weight of (a), (b), and (c).

14. A curable, solventborne film-forming composition comprising:
(a) a polymeric binder comprising a copolymer, said copolymer being a polymerization product of:
(i) 10 to 30 percent by weight, based on the total weight of monomers used to prepare the copolymer, of a donor monomer having the following structure (I): 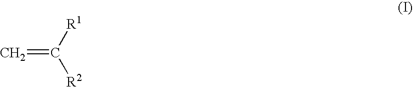
wherein R¹ comprises linear or branched C₁ to C₄ alkyl, and R² comprises methyl, linear, cyclic or branched C₁ to C₂₀ alkyl or alkenyl;
(ii) 5 to 25 percent by weight, based on the total weight of monomers used to prepare the copolymer, of a monomer having aromatic functionality;
(iii) 0 to 60 percent by weight, based on the total weight of monomers used to prepare the copolymer, of an acceptor monomer comprising an ethylenically unsaturated monomer containing secondary hydroxyl groups; and
(iv) 15 to 50 percent by weight, based on the total weight of monomers used to prepare the copolymer, of an acceptor monomer comprising an ethylenically unsaturated monomer containing primary hydroxyl groups;
wherein at least 15 mol percent of the copolymer comprises residues having the following alternating structural units:
-[DM-AM]-
wherein DM represents a residue from a donor monomer, and AM represents a residue from an acceptor monomer;
(b) an aminoplast curing agent; and
(c) 3 to 5 percent by weight, based on the total weight of (a), (b), and (c), of a compound comprising a capped isocyanate-functional material.

15. The film-forming composition of claim 14, wherein the donor monomer (i) comprises isobutylene, diisobutylene, dipentene, and/or isoprenol.

16. The film-forming composition of claim 14, wherein the group R² of the donor monomer of structure I includes a functional group comprising hydroxy, epoxy, carboxylic acid, ether, carbamate, and/or amide.

17. The film-forming composition of claim 14, wherein the monomer (ii) is an acceptor monomer comprising benzyl acrylate.

18. The film-forming composition of claim 14, wherein the monomer (ii) is a donor monomer comprising alpha-methyl styrene and/or styrene.

19. The film-forming composition of claim 14, wherein the acceptor monomer (iii) comprises a reaction product of an ethylenically unsaturated, epoxy functional monomer and a carboxylic acid having from 13 to 20 carbon atoms or primary amine having from 13 to 20 carbon atoms, or an ethylenically unsaturated acid- or amine-functional monomer and an epoxy compound which is not addition polymerizable containing at least 5 carbon atoms.

20. The film-forming composition of claim 14, wherein the copolymer is substantially free of maleic anhydride monomer segments, maleate ester monomer segments, fumaric acid monomer segments, and fumarate ester monomer segments.
